(19) United States
(12) Patent Application Publication
(10) Pub. No.: US 2003/0122820 A1
(43) Pub. Date: Jul. 3, 2003

(54) Object culling in zone rendering

(76) Inventor: Peter L. Doyle, El Dorado Hills, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/039,024

(22) Filed: Dec. 31, 2001

(51) Int. Cl. G06T 15/40

(52) U.S. Cl. 345/421

(57) ABSTRACT

An apparatus and method for providing back face culling and degenerate object removal functions in the first pass binning process. The need to replicate such objects into command structures that are binned is eliminated. By removing the back facing polygons and degenerate objects prior to replicating them into bins, subsequent per object operations are avoided for each replication of the objects within the bins. Consequently, this reduces memory bandwidth requirements and the memory footprint required for the bin command structures, and possibly eliminates the output of state-setting commands that would otherwise be required to properly render the eliminated objects. Processing of such objects during the rendering phase is also avoided.

### BACKGROUND

1. Field

The present invention relates generally to graphics systems and more particularly to graphics-rendering systems.

2. Background Information

Computer graphics systems are commonly used for displaying graphical representations of objects on a two-dimensional video display screen. Current computer graphics systems provide highly detailed representations and are used in a variety of applications. In typical computer graphics systems, an object to be represented on the display screen is broken down into graphics primitives. Primitives are basic components of a graphics display and may include points, lines, vectors and polygons, such as triangles and quadrilaterals. Typically, a hardware/software scheme is implemented to render or draw the graphics primitives that represent a view of one or more objects being represented on the display screen.

The primitives of the three-dimensional objects to be rendered are defined by a host computer in terms of primitive data. For example, when the primitive is a triangle, the host computer may define the primitive in terms of X, Y and Z coordinates of its vertices, as well as the red, green and blue (R, G and B) color values of each vertex. Additional primitive data may be used in specific applications.

Image rendering is the conversion of a high-level object-based description into a graphical image for display on some display device. For example, an act of image rendering occurs during the conversion of a mathematical model of a three-dimensional object or scene into a bitmap image. Another example of image rendering is converting an HTML document into an image for display on a computer monitor. Typically, a hardware device referred to as a graphics-rendering engine performs these graphics processing tasks. Graphics-rendering engines typically render scenes into a buffer that is subsequently output to the graphical output device, but it is possible for some rendering-engines to write their two-dimensional output directly to the output device. The graphics-rendering engine interpolates the primitive data to compute the display screen pixels that represent the each primitive, and the R, G and B color values of each pixel.

A graphics-rendering system (or subsystem), as used herein, refers to all of the levels of processing between an application program and a graphical output device. A graphics engine can provide for one or more modes of rendering, including zone rendering. Zone rendering attempts to increase overall 3D rendering performance by gaining optimal render cache utilization, thereby reducing pixel color and depth memory read/write bottlenecks. In zone rendering, a screen is subdivided into an array of zones and per-zone instruction bins, used to hold all of the primitive and state setting instructions required to render each sub-image, are generated. Whenever a primitive intersects (or possibly intersects) a zone, that primitive instruction is placed in the bin for that zone. Some primitives will intersect more than one zone, in which case the primitive instruction is replicated in the corresponding bins. This process is continued until the entire scene is sorted into the bins. Following the first pass of building a bin for each zone intersected by a primitive, a second zone-by-zone rendering pass is performed. In particular, the bins for all the zones are rendered to generate the final image.

Zone rendering performance, particularly the binning process, is especially important in unified memory architectures where memory bandwidth and memory footprint are at a premium. In conventional systems, replication of non-visible objects such as back facing and/or degenerate objects in zone rendering bins typically results in reduced performance, as such objects can comprise more than one half of the objects processed for the image. Processing such non-visible objects unnecessarily increases memory bandwidth requirements and the memory footprint required for bin command structures. Moreover, the graphics-rendering engine utilizes additional memory bandwidth to process the binned command structures associated with the back-facing and degenerate objects.

What is needed therefore is a method, apparatus and system for minimizing the effect of back face culling and degenerative objects in the binning process.

### BRIEF DESCRIPTION OF THE DRAWINGS

FIG. 1 illustrates a block diagram of an embodiment of a computer system including an embodiment of a graphics device for object culling for zone rendering.

FIG. 2 illustrates a block diagram of an embodiment of a graphics device including a graphics-binning engine for processing a scene input list including delta states, graphics-rendering engine and bins.

FIG. 3 illustrates a depiction of an embodiment of a zone renderer screen view including zones and geometrical primitives.

FIG. 4 illustrates a block diagram of the first pass binning process including face and degenerate object culling.

FIG. 5 illustrates a detailed block diagram of a graphics pipeline including the setup stage where face and degenerate object culling occur in the first pass binning process.

FIG. 6(a) illustrates an embodiment of an exemplary front-facing triangle.

FIG. 6(b) illustrates an embodiment of an exemplary back-facing triangle.

FIG. 7 illustrates a flow diagram of an embodiment of a process for object face culling in the first pass binning process.

FIG. 8 illustrates a flow diagram of an embodiment of a process for object face culling in the first pass binning process.

### DETAILED DESCRIPTION

The present invention optimizes graphics performance during zone rendering by providing back face culling and degenerate object removal functions in the first pass binning process. By removing the back facing polygons and degenerate objects prior to replicating them into bins, subsequent per object operations are avoided for each replication of the objects within the bins.

In particular, the need to replicate back facing and degenerate objects into command structures that are binned is eliminated. Consequently, this reduces memory bandwidth requirements and the memory footprint required for the bin command structures, and eliminates the output of associated state-setting commands that would otherwise be required to properly render the discarded objects. Processing of such objects during the rendering phase is also eliminated. In particular, reading object descriptions from the bin command structures is avoided thus reducing memory bandwidth requirements.

In the detailed description, numerous specific details are set forth in order to provide a thorough understanding of the present invention. However, it will be understood by those skilled in the art that the present invention maybe practiced without these specific details. In other instances, well-known methods, procedures, components and circuits have been described in detail so as not to obscure the present invention.

Some portions of the detailed description that follow are presented in terms of algorithms and symbolic representations of operations on data bits or binary signals within a computer. These algorithmic descriptions and representations are the means used by those skilled in the data processing arts to convey the substance of their work to others skilled in the art. An algorithm is here, and generally, considered to be a self-consistent sequence of steps leading to a desired result. The steps include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities. Unless specifically stated otherwise as apparent from the following discussions, it is appreciated that throughout the specification, discussions utilizing such terms as “processing” or “computing” or “calculating” or “determining” or the like, refer to the action and processes of a computer or computing system, or similar electronic computing device, that manipulate and transform data represented as physical (electronic) quantities within the computing system's registers and/or memories into other data similarly represented as physical quantities within the computing system's memories, registers or other such information storage, transmission or display devices.

Embodiments of the present invention may be implemented in hardware or software, or a combination of both. However, embodiments of the invention may be implemented as computer programs executing on programmable systems comprising at least one processor, a data storage system (including volatile and non-volatile memory and/or storage elements), at least one input device, and at least one output device. Program code may be applied to input data to perform the functions described herein and generate output information. The output information may be applied to one or more output devices, in known fashion. For purposes of this application, a processing system includes any system that has a processor, such as, for example, a digital signal processor (DSP), a micro-controller, an application specific integrated circuit (ASIC), or a microprocessor.

The programs may be implemented in a high level procedural or object oriented programming language to communicate with a processing system. The programs may also be implemented in assembly or machine language, if desired. In fact, the invention is not limited in scope to any particular programming language. In any case, the language may be a compiled or interpreted language.

The programs may be stored on a storage media or device (e.g., hard disk drive, floppy disk drive, read only memory (ROM), CD-ROM device, flash memory device, digital versatile disk (DVD), or other storage device) readable by a general or special purpose programmable processing system, for configuring and operating the processing system when the storage media or device is read by the processing system to perform the procedures described herein. Embodiments of the invention may also be considered to be implemented as a machine-readable storage medium, configured for use with a processing system, where the storage medium so configured causes the processing system to operate in a specific and predefined manner to perform the functions described herein.

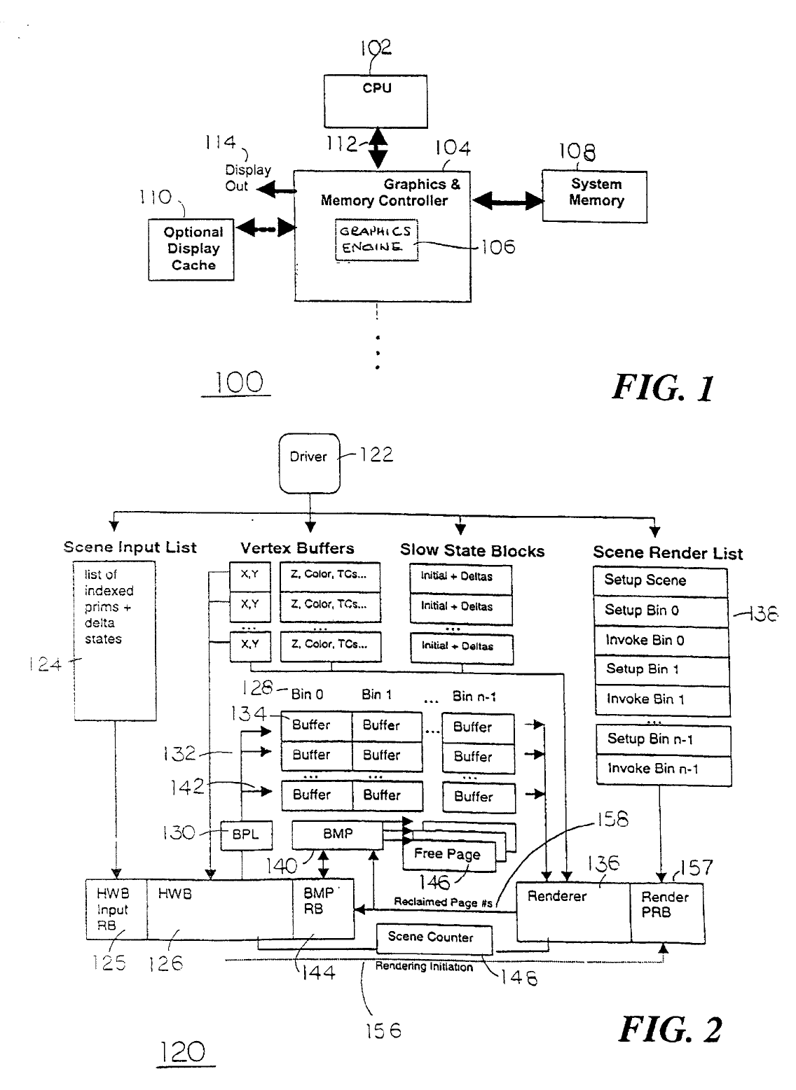

An example of one such type of processing system is shown in FIG. 1. Sample system 100 may be used, for example, to execute the processing for methods in accordance with the present invention, such as the embodiment described herein. Sample system 100 is representative of processing systems based on the microprocessors available from Intel Corporation, although other systems (including personal computers (PCs) having other microprocessors, engineering workstations, set-top boxes and the like) may also be used. In one embodiment, sample system 100 may be executing a version of the WINDOWS.TM. operating system available from Microsoft Corporation, although other operating systems and graphical user interfaces, for example, may also be used.

FIG. 1 is a block diagram of a system 100 of one embodiment of the present invention. The computer system 100 includes central processor 102, graphics and memory controller 104 including graphics device 106, memory 108 and display device 114. Processor 102 processes data signals and may be a complex instruction set computer (CISC) microprocessor, a reduced instruction set computing (RISC) microprocessor, a very long instruction word (VLIW) microprocessor, a process implementing a combination of instruction sets, or other processor device, such as a digital signal processor, for example. Processor 102 may be coupled to common bus 112 that transmits data signals between processor 102 and other components in the system 100. FIG. 1 is for illustrative purposes only. The present invention can also be utilized in a configuration including a descrete graphics device.

Processor 102 issues signals over common bus 112 for communicating with memory 108 or graphics and memory controller 104 in order to manipulate data as described herein. Processor 102 issues such signals in response to software instructions that it obtains from memory 108. Memory 108 may be a dynamic random access memory (DRAM) device, a static random access memory (SRAM) device, or other memory device. Memory 108 may store instructions and/or data represented by data signals that may be executed by processor 102, graphics device 106 or some other device. The instructions and/or data may comprise code for performing any and/or all of the techniques of the present invention. Memory 108 may also contain software and/or data. An optional cache memory 110 may be used to speed up memory accesses by the graphics device 106 by taking advantage of its locality of access. In some embodiments, graphics device 106 can off-load from processor 102 many of the memory-intensive tasks required for rendering an image. Graphics device 106 processes data signals and may be a complex instruction set computer (CISC) microprocessor, a reduced instruction set computing (RISC) microprocessor, a very long instruction word (VLIW) microprocessor, a process implementing a combination of instruction sets, or other processor device, such as a digital signal processor, for example. Graphics device 106 may be coupled to common bus 112 that transmits data signals between graphics device 106 and other components in the system 100, including render cache 110 and display device 114. Graphics device 106 includes rendering hardware that among other things writes specific attributes (e.g. colors) to specific pixels of display 114 and draw complicated primitives on display device 114. Graphics and memory controller 104 communicates with display device 114 for displaying images rendered or otherwise processed by a graphics controller 104 for displaying images rendered or otherwise processed to a user. Display device 114 may comprise a computer monitor, television set, flat panel display or other suitable display device.

Memory 108 stores a host operating system that may include one or more rendering programs to build the images of graphics primitives for display. System 100 includes graphics device 106, such as a graphics accelerator that uses customized hardware logic device or a co-processor to improve the performance of rendering at least some portion of the graphics primitives otherwise handled by host rendering programs. The host operating system program and its host graphics application program interface (API) control the graphics device 106 through a driver program.

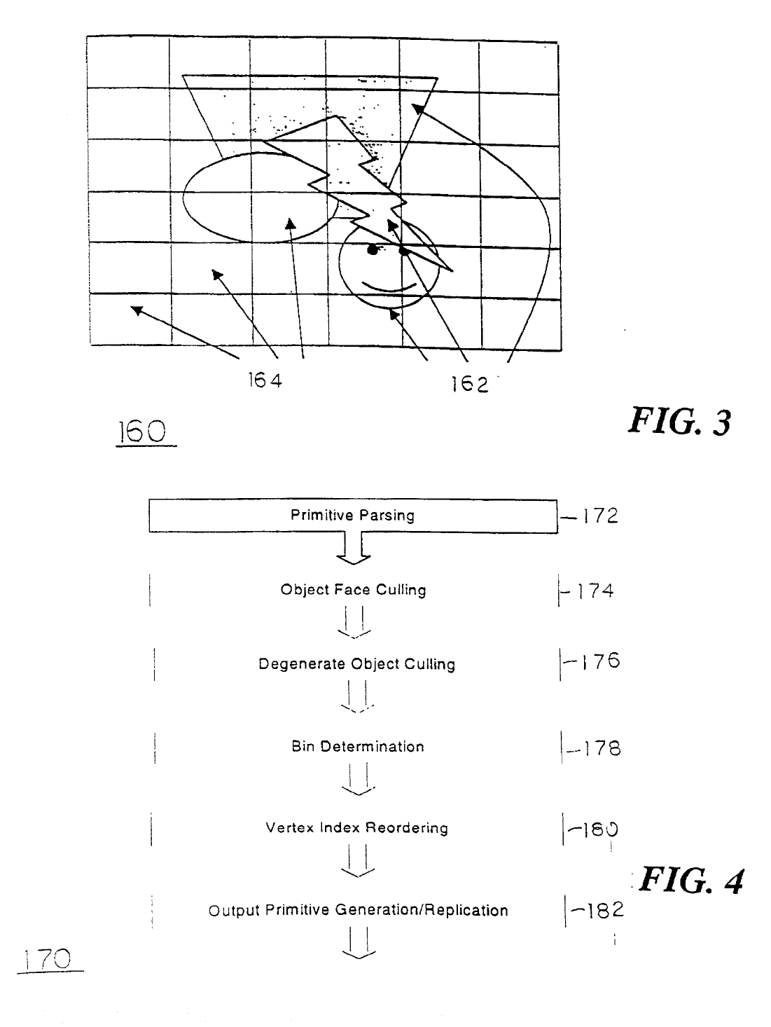

Referring to FIG. 3, an embodiment 160 of various screen objects implemented on a zone rendering system 120 (shown in FIG. 2) is illustrated. A screen object to be presented on the display screen is broken down into graphics primitives 162. Primitives 162 may include, but are not limited to, graphical objects such as polygons (e.g., triangles and quadrilaterals), lines, points and vectors. The graphics engine 106 is implemented to render, or draw, the graphics primitives 162 that represent a view of one or more screen objects being represented on the display screen. In zone rendering, a screen is subdivided into an array of zones 164 commonly screen-space rectangles although other geometric variants may be used as well. Each zone 164 is associated with a bin. Each bin 128 includes a chained series of command buffers 134 stored within non-contiguous physical memory pages. The bins 128 are thus preferably implemented as a chain of independent physical pages.

Rendering performance improves as a result of the primitives 162 being divided into zones 164 that are aligned to the render cache 110. Since the graphics device 106 is only working on a small portion of the screen at a time (i.e. a zone 164), it is able to hold the frame buffer contents for the entire zone 164 in a render cache 110. The dimensions of the zone 164 are typically a constant tuned to the size and organization of the render cache 110. It is by this mechanism that the render cache 110 provides optimal benefits—reuse of cached data is maximized by exploiting the spatial coherence of a zone 164. Through use of the zone rendering mode, only the minimum number of color memory writes need be performed to generate the final image one zone 164 at a time, and color memory reads and depth memory reads and writes can be minimized or avoided altogether. Use of the render cache 110 thus significantly reduces the memory traffic and improves performance relative to a conventional renderer that draws each primitive completely before continuing to the next primitive.

The process of assigning primitives (and their attributes) 162 to zones 164 is referred to as binning. “Bin” 128 refers to the abstract buffer used for each zone—where a bin 128 will typically be realized as a series of instruction batch buffers 134. Binning performs the necessary computations to determine what primitives 162 lie in what zones 164 and can be performed by dedicated hardware and/or software implementations.

When a primitive 162 intersects a zone 164, the corresponding primitive instruction is placed in the bin 128 associated with the zone 164 intersected. Per-zone instruction bins 128 are thus used to hold primitive instructions and state-setting instructions required to render each sub-image and are generated by comparing the screen-space extent of each primitive 162 to the array of zones 164.

Thus, as the primitives 162 are received, the present invention determines which zone(s) 164 each primitive 162 intersects, and replicates the primitive instructions into a bin 128 associated with each of these zones 164.

In one typical implementation, a driver 122 writes out a set of primitive instructions to be parsed by the graphics-binning engine 126. For each zone 164 intersected by a primitive 162, the graphics-binning engine writes corresponding primitive instructions into buffers 134 associated with the zones 164 intersected. Some primitives 162 will intersect more than one zone 164, in which case the primitive instruction is replicated in bins 128 corresponding to the intersected zones 164. For example, the lightning bolt depicted in FIG. 3 intersects nine zones 164. This process is continued until the entire scene is sorted into bins 128.

FIG. 4 illustrates a detailed block diagram of an embodiment 170 of a binning process. Prior to output primitive generation/replication 182, the graphics-binning engine 126 carries out binning through a number of steps, including but not limited to, primitive parsing 172, object face culling 174, degenerative object culling 176, bin determination 178, vertex index reordering 180.

One skilled in the art will recognize that the present invention is not dependent upon a particular method for face and degenerate object culling. The methods discussed herein are for exemplary purposes only.

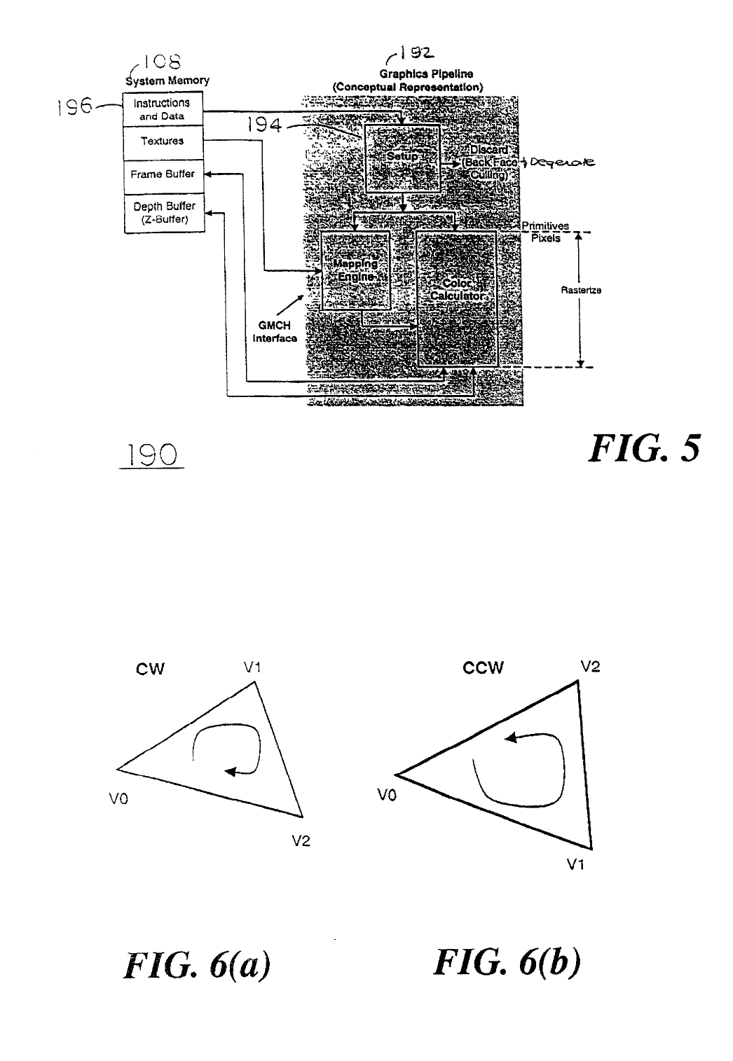

Referring to FIG. 5, an embodiment 200 of a graphics pipeline 192 including setup stage 194 where object face-orientation and degenerate object culling are performed is illustrated.

When modeling solid 3D objects using polygonal representations, such as decomposing the surface of a closed object into triangles, it is usually advantageous to employ a consistent definition of the outside (versus the inside) face of a surface polygon. One such definition uses the ordering of the vertices of the surface polygon. For example, the outside face of a polygon can be defined as having a clockwise ordering of vertices (V0, V1, V2) as shown in FIG. 6(a), where the inside face would therefore have a counterclockwise ordering of vertices (V0, V1, V2) as shown in FIG. 6(b). Conversely, the outside face of a polygon can be defined as having a counterclockwise ordering of vertices, where the inside face would therefore have a clockwise order.

In a typical 3D graphics application, only the outside faces of solid objects are visible, i.e., (a) objects do not contain holes through which inside faces could be viewed, and (b) the 3D viewpoint cannot be placed inside of a 3D object. Given these conditions, outside faces of an object that face away from the viewpoint (“back-facing” polygons) need not be rendered, as they will be completely obscured by outside faces that face towards the viewpoint (front-facing polygons). In a typical renderer scene, about one half of the object faces will be front facing, and about one half of the objects will be back facing. Neither processing nor rendering back-facing polygons realizes significant image-rendering performance gains.

Per an object face culling function 196, the graphics-binning engine 126 removes back facing objects prior to replicating object commands into bins 128. A culling mode, specified by a state-setting instruction, controls the object culling function. Object face polygons, in particular back facing polygons, are removed prior to replicating object commands and attributes into the intersecting bins 128. In particular, triangle objects are optionally discarded based upon the “face orientation” of the object. The object culling operation provides for “back face culling,” although front facing objects can alternatively be discarded. Back-face culling differentiates between triangle objects facing the viewer and triangle objects facing away from the viewer. When a primitive 162 that is part of a closed object faces away from a viewer, the primitive 162 is not drawn and subsequent processing and calculation related to the primitive 162 avoided.

As illustrated in FIGS. 6(a) and (b), the orientation of the triangle is defined by the clockwise (CW) or counterclockwise (CCW) “winding order” image of the vertices of the triangle.

The state variable Cull Mode (set via a state-setting instruction) controls the selection of orientation(s) to be discarded, as follows:

CULLMODE_NONE: face-culling operation is disabled

CULLMODE_CW: triangles with clockwise (typically indicating “front facing”) orientation are discarded

CULLMODE_CCW: triangles with counterclockwise (typically indicating “back facing”) orientation are discarded

In a typical implementation, if the CULLMODE_NONE mode is selected, the face culling operation is disabled and the triangle is not discarded regardless of its orientation. If the CULLMODE_CW mode is selected and the triangle winding order indicates that the image of the triangle is clockwise, then the triangle is discarded. If the CULLMODE_CCW mode is selected and the triangle winding order indicates that the image of the triangle is counterclockwise, then the triangle is discarded. The outside of the object is thus distinguished by using a specific winding order and ensuring that the setting of the object face culling mode agrees with this winding order. For example, if a CW orientation is used to define the outside face of a triangle, and back-facing triangles are to be removed, then CULLMODE_CCW must be specified.

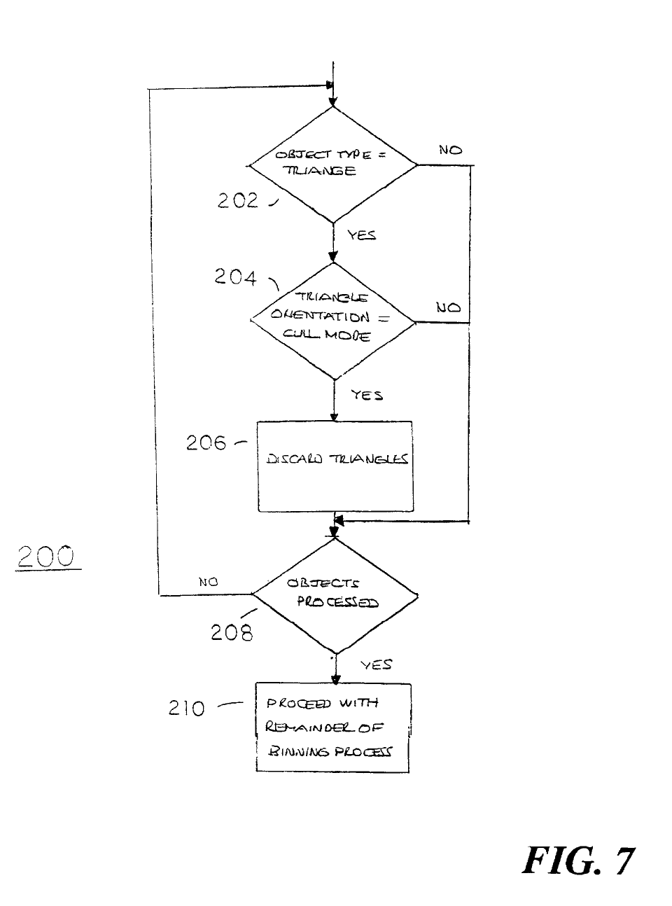

FIG. 7 illustrates a flow diagram of an embodiment 200 of a process for object face culling in the binning pipeline. In particular, if the object type is a triangle (step 202), its orientation is used to determine whether it should be discarded (step 204). If the orientation of the triangle is the same as the orientation selected for culling (step 204), the triangle is discarded (step 206) and the object is no longer binned.

Else, if the orientation of the triangle is not the same as the orientation selected for culling (step 204), the object is not eliminated from further binning at this stage.

Else, if the object is not a triangle (e.g. object is a line or point) (step 202), the object is not eliminated from further binning at this stage.

After all the objects have been processed (step 208), the graphics-binning engine 126 continues binning those objects that are not culled via degenerate object-culling, bin determination, vertex index reordering and output primitive generation/replication (step 210).

One skilled in the art will recognize that other methods for performing object-face culling could be used as well in the first pass binning process.

Referring to FIG. 5, per a degenerate face culling function 196, the graphics-binning engine 126 removes degenerate objects prior to replicating object commands into bins 128. Degenerate object culling eliminates those objects that are not viewable after transformation. Degenerate objects include, but are not limited to:

POINTS: points with zero effective width (i.e., the radius quantized to zero);

LINES: endpoints are coincident;

TRIANGLES: vertices are collinear or coincident; and

RECTANGLES: two or more corner vertices are coincident.

Additionally, embodiments of the present invention discard non-degenerate objects that are invisible due to the fact that the area they define does not contain (i.e. cover) any pixels. For example, primitives, such as rectangles that do not cover at least one pixel, are discarded as well. For example, in operation, if an object cannot light any pixels, it is discarded.

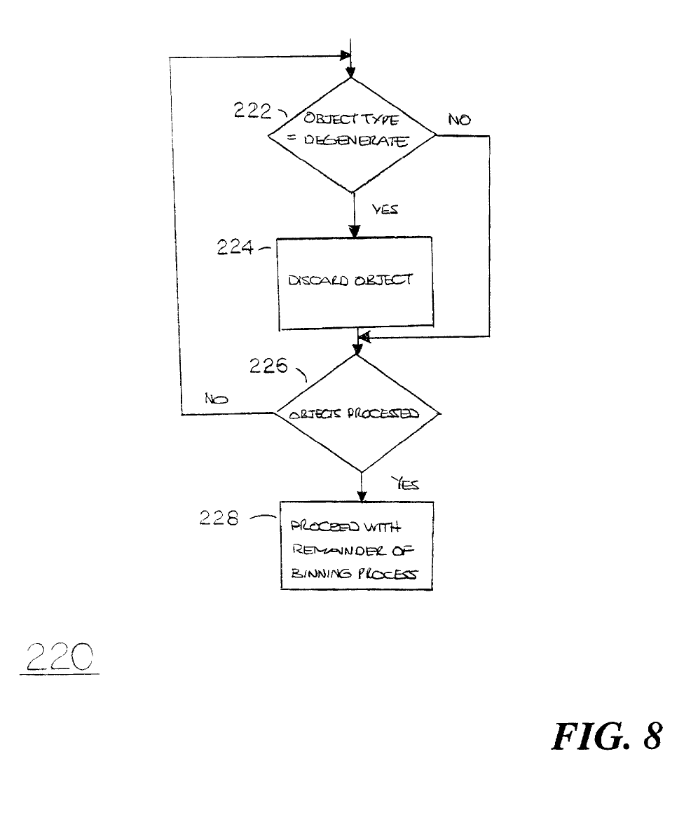

FIG. 8 illustrates a flow diagram of an embodiment 220 of a process for degenerate object culling in the binning pipeline. In particular, if the object type is a degenerate object (step 222), the object is discarded (step 224) and the object is no longer binned.

Else, if the object is not a degenerate object (step 222), the object is not eliminated from further binning at this stage.

After all the objects have been processed (step 226), the graphics-binning engine 126 performs operations, such as bin determination 178, vertex index reordering 180 and output primitive generation/replication 182 operations, on the remaining objects.

One skilled in the art will recognize that other methods for performing degenerate object culling could be used as well in the first pass binning process.

Bin determination refers to assigning the instructions and attributes associated with the remaining non-culled primitives 142 to bins associated with zones 144 intersected. During bin determination, as the primitives 142 are received, the present invention determines which zone(s) 144 each primitive 142 has a possibility of touching. When a primitive 162 intersects a zone 164, the corresponding primitive instruction is placed in the bin 128 associated with the zone 164 intersected. Per-zone instruction bins 128 are thus used to hold primitive instructions and state setting instructions required to render each sub-image and are generated by comparing the screen-space extent of each primitive 162 to the array of zones 164. After the present invention determines which zone(s) 164 each primitive 162 intersects, vertex index reordering is then performed and the primitive instructions replicated into a bin 128 associated with each of these zones 164. By removing the back facing polygons and degenerate objects prior to replicating them into bins, subsequent per object operations are avoided for each replication of the objects within the bins. Consequently, this reduces memory bandwidth requirements and the memory footprint required for the bin command structures.

By discarding back-facing and degenerate objects prior to replication in the first binning pass, object and state-setting commands that would otherwise be required to properly render the discarded objects do not need to be generated or processed. In particular, writing and reading extraneous object descriptions to and from the bin command structures are avoided thus reducing memory bandwidth. In particular, once all the primitives 162 are sorted and the command structures completed, graphics-rendering engine 136 renders the scene one zone 164 at a time. The bins 128 for all the zones 164 are rendered to generate the final image, with each scene rendered one zone 164 at a time. The order with which the zones 164 are rendered is not significant. All bins 128 associated with primitives 162 that touch pixels within a particular zone 164 are rendered before the next zone 164 is rendered. A single primitive 162 may intersect many zones 164, thus requiring multiple replications. As a result, primitives 162 that intersect multiple zones 164 are rendered multiple times (i.e. once for each zone 164 intersected).

Having now described the invention in accordance with the requirements of the patent statutes, those skilled in the art will understand how to make changes and modifications to the present invention to meet their specific requirements or conditions. Such changes and modifications may be made without departing from the scope and spirit of the invention as set forth in the following claims.

What is claimed is:

1. An apparatus for processing graphical objects, comprising:
a plurality of binning memory areas associated with regions that are intersected by graphical objects;
a binning engine for receiving the graphical objects, wherein the binning engine identifies and discards graphical objects that would not be viewable to a user and replicates the remaining graphical objects into the plurality of binning memory areas; and
a rendering engine for rendering the graphical objects in the plurality of binning memory areas.

2. The apparatus of claim 1 wherein the binning engine identifies and discards back facing graphical objects.

3. The apparatus of claim 2 wherein the graphical objects include back facing triangles.

4. The apparatus of claim 1 wherein the binning engine identifies and discards front facing graphical objects.

5. The apparatus of claim 4 wherein the graphical objects include front facing triangles.

6. The apparatus of claim 1 wherein the binning engine identifies and discards degenerate graphical objects.

7. The apparatus of claim 6 wherein the degenerate graphical objects include degenerate points, lines, triangles and rectangles.

8. The apparatus of claim 1 wherein the binning engine identifies and discards those graphical objects that would not be viewable to a user per an instruction stream.

9. The apparatus of claim 1 wherein the binning engine further assign those graphical objects that are not discarded to the plurality of binning memory areas associated with the regions intersected.

10. The apparatus of claim 1 wherein the binning engine identifies and discards those graphical objects having vertices disposed in a specific orientation.

11. A method for processing graphical objects, comprising:
establishing a plurality of binning memory areas associated with regions that are intersected by graphical objects;
identifying and discarding graphical objects that would not be viewable to a user;
replicating the remaining graphical objects into the plurality of binning memory areas; and
rendering the graphical objects in the plurality of binning memory areas.

12. The method of claim 11 wherein identifying and discarding those graphical objects that would not be viewable to a user further comprises:
identifying and discarding back facing graphical objects that would not be viewable to a user after being rendered.

13. The method of claim 12 wherein the graphical objects include back facing triangles.

14. The method of claim 11 wherein identifying and discarding those graphical objects that would not be viewable to a user further comprises:
identifying and discarding front facing graphical objects that would not be viewable to a user.

15. The method of claim 14 wherein the graphical objects include front facing triangles.

16. The method of claim 11 wherein identifying and discarding those graphical objects that would not be viewable to a user further comprises:
identifying and discarding degenerate graphical objects that would not be viewable to a user.

17. The method of claim 16 wherein the degenerate graphical objects include degenerate points, lines, triangles and rectangles.

18. The method of claim 11 wherein the identifying and discarding those graphical objects that would not be viewable to a user further comprises:
identifying and discarding those graphical objects that would not be viewable to a user per an instruction stream.

19. The method of claim 11 further comprising:
assigning those graphical objects that are not discarded to the memory areas associated with the regions intersected.

20. The method of claim 11 further comprising:
identifying and discarding those graphical objects having vertices disposed in a specific orientation.

21. A machine readable medium having stored therein a plurality of machine readable instructions executable by a processor to process graphical objects, the machine readable instructions comprising:
instructions to establish a plurality of binning memory areas associated with regions that are intersected by graphical objects;
instructions to identify and discard graphical objects that would not be viewable to a user;
instructions to replicate the remaining graphical objects into the plurality of binning memory areas; and
instructions to render the graphical objects in the plurality of binning memory areas.

22. The machine readable medium of claim 21 wherein instructions to identify and discard those graphical objects that would not be viewable to a user further comprises:
instructions to identify and discard back facing graphical objects that would not be viewable to a user.

23. The machine readable medium of claim 22 wherein the graphical objects include back facing triangles.

24. The machine readable medium of claim 21 wherein instructions to identify and discard those graphical objects that would not be viewable to a user further comprises:
instructions to identify and discard front facing graphical objects that would not be viewable to a user.

25. The machine readable medium of claim 24 wherein the graphical objects include front facing triangles.

26. The machine readable medium of claim 21 wherein instructions to identify and discard those graphical objects that would not be viewable to a user further comprises:
instructions to identify and discard degenerate graphical objects that would not be viewable to a user.

27. The machine readable medium of claim 26 wherein the degenerate graphical objects include degenerate points, lines, triangles and rectangles.

28. The machine readable medium of claim 21 wherein the instructions to identify and discard those graphical objects that would not be viewable to a user further comprises:
instructions to identify and discard those graphical objects that would not be viewable to a user after being rendered per an instruction stream.

29. The machine readable medium method of claim 21 further comprising:
instructions to assign those graphical objects that are not discarded to the memory areas associated with the regions intersected.

20. The machine readable medium method of claim 11 further comprising:
instructions to identify and discard those graphical objects having vertices disposed in a specific orientation.
